(19) United States
(12) Patent Application Publication
(10) Pub. No.: US 2023/0201637 A1
(43) Pub. Date: Jun. 29, 2023

(54) RESPIRATOR MASK

(71) Applicant: Eurofilters Holding N.V., Overpelt (BE)

(72) Inventors: Ralf Sauer, Overpelt (BE); Jan Schultink, Overpelt (BE)

(73) Assignee: Eurofilters Holding N.V., Overpelt (BE)

(21) Appl. No.: 17/927,133

(22) PCT Filed: May 10, 2021
(86) PCT No.: PCT/EP2021/062312

§ 371 Date: Nov. 22, 2022

(30) Foreign Application Priority Data
May 28, 2020 (EP) 20177109.4

(51) Int. Cl. A62B 23/02; A62B 18/08; B01D 39/16

(52) U.S. Cl. CPC A62B 23/025; A62B 18/084; B01D 39/163; B01D 2239/0654; B01D 2239/0283; B01D 2239/0672; B01D 2239/0618; B01D 2239/1291; B01D 2239/0435; B01D 2239/0233

(57) ABSTRACT

The invention provides a respirator mask comprising a filter material piece made of an air-permeable material and at least one securing band, wherein the air-permeable material comprises at least one layer of a non-woven fabric and the layer of a non-woven fabric is creped, and wherein the at least one securing band is designed for securing the respirator mask to the head.

The invention relates to a respirator mask.

Respirator masks consistently cover the wearer's mouth and nose with a filter material and are used to protect them from airborne pollutants and to protect the environment from exhaled bacteria and viruses. In this regard, the term includes, among others, in particular a surgical mask, medical face masks and filtering half masks.

The filter material used nowadays generally consists of a non-woven fabric made of plastic material. Many respirator masks are intended for single use and are disposed of afterwards.

Regarding the typical shapes, “medical face masks according to DIN EN 14683” and “filtering half masks according to DIN EN 149” differ.

While medical face masks mostly have a rectangular shape with several folds, filtering half masks are often complexly shaped in three dimensions to allow a better fit to the face. This is taken into account in DIN EN 149 by the fact that requirements must be met with regard to the leakage of the mask.

Respirator masks are generally one size, sometimes differentiated for children and adults. FFP masks come in several forms. However, these shapes cannot be adapted to the shape of the face. This means that the fit on the head/face is often not optimum.

Another requirement for respirator masks is the breathing resistance. A high breathing resistance makes breathing more difficult and leads to less acceptance of the respirator mask.

In view of this, the object of the invention is to provide a respirator mask that is easy to manufacture and has good filtering and protective properties with low breathing resistance.

This object is achieved by a respirator mask according to claim 1.

The invention provides a respirator mask comprising a filter material piece made of an air-permeable material and at least one securing band,
wherein the air-permeable material comprises at least one layer of non-woven fabric and the layer of non-woven fabric is creped, and
wherein the at least one securing band is designed to secure the respirator mask to the head.

The filter part of the respirator mask in the form of the filter material piece is accordingly made of an air-permeable material that may have a construction with one or more layers. The creping of the non-woven fabric layer leads to an increase in the flow-through area and thus to a corresponding reduction in breathing resistance.

For creping the non-woven layer, the Micrex/microcreper process may be used in particular. Merely by way of example, reference is made to WO 2007/079502.

For the purposes of the present invention, a “non-woven fabric” means an entangled mesh which has undergone a bonding step (non-woven bonding step) so that it has sufficient strength to be wound into rolls or unwound from these, in particular by machine (i.e. on an industrial scale). The minimum web tension required for such a winding into rolls is 0.044 N/mm. The web tension should not be higher than 10% to 25% of the minimum maximum tensile force (according to DIN EN 29073-3:1992-08) of the material to be wound. This results in a minimum maximum tensile force for a material to be wound of 8.8 N per 5 cm strip width.

A “fibre web” (or just “web”) corresponds to an entangled mesh, which, however, has not undergone a bonding step, so that, in contrast to a non-woven fabric, such an entangled mesh does not have sufficient strength to be wound into rolls or unwound from these by machine, for example.

The term “non-woven fabric” is used in other words as defined in ISO standard ISO 9092:1988 or CEN standard EN 29092. Details on the use of the definitions and/or processes described therein may also be found in the textbook “Vliesstoffe”, H. Fuchs, W. Albrecht, WILEY-VCH, 2012.

“Fibres” refers to both fibres of finite length (e.g. staple fibres) and fibres of theoretically infinite length, i.e. continuous fibres or filaments.

The air-permeable material of the respirator mask may be creped. When the entire air-permeable material, i.e. all layers, are creped, an increased stretchability of the filter material piece is achieved, resulting in an improved fit of the respirator mask. Increasing the surface area through creping may further lead to a softer feel, improving skin-friendliness, and a better moisture absorption.

The crepe direction, i.e. the direction of the crepe folds, may be designed in such a way that the crepe folds run essentially horizontally or essentially vertically in the intended use of the respirator mask.

The respirator masks described may comprise a further filter material piece made of an air-permeable material, the further filter material piece comprising at least one layer of a non-woven fabric which is creped, wherein the two filter material pieces are partially welded together along their edge.

This allows in particular the manufacturing of a filtering half mask. The two filter material pieces, which form the filter part here, are disposed on top of each other.

The two filter material pieces of the respirator mask may have a polygonal shape, wherein the filter material pieces are not welded together along one edge. The shape of the filter material pieces may be rectangular or hexagonal in particular. Both filter material pieces may have the same shape and dimensions; in particular, they may fit exactly on top of each other.

The welding of the filter material pieces is an aspect independent of the welding of several layers of a filter material piece. Thus, along one edge of the two filter material pieces, these two may be welded together and each filter material piece may consist of several (previously) welded layers; however, the latter layer welding, which leads to a corresponding laminate, may lack or may also only be present at individual edges of the layers of a filter material piece.

The filter part of the (finished but unused) respirator mask may have (in plan view) a polygonal, in particular rectangular or hexagonal shape. In the hexagonal shape, two adjacent right angles may be provided.

The two filter material pieces may be welded together along all remaining edges. This leaves exactly one edge of the polygon unwelded. The unwelded edge creates the opening of the respirator mask for the face of the wearer/user. In the case of two filter material pieces or a filter part with a rectangular shape, the unwelded edge may in particular be an edge between two right angles.

These features allow the respirator mask to be manufactured very easily.

The features and properties of an air-permeable layer or filter material piece described above and below may be given and implemented in the same way for each of the filter material pieces or their air-permeable layer, in particular in the case of a respirator mask comprising two filter material pieces.

One embodiment of the structure of the air-permeable material for the respirator mask according to the invention provides a multi-layer structure with a layer sequence described below:
a support layer, one or two fine filter layers and a further support layer.

In particular, the support layer may be a spunbond non-woven fabric and the fine filter layer may be a meltblown non-woven fabric. In this case, a SMS or SMMS structure is provided.

One or more layers may be creped. If only one layer is creped, the fine filter layer in particular may be creped.

In the case of the respirator masks described, the non-woven fabric may comprise or consist of fibres formed from one or more recycled plastic materials.

The term “recycled plastic material” is synonymous with plastic material recyclates. A recycled plastic material or plastic material recyclate is obtained from the recycling of production, processing or post-consumer waste. The processing into recyclate typically takes the form of regrind, reprocessed material, regenerates or compounds, agglomerates or compacted material. The recyclate produced is used again in the processing of plastic material products. Recycled plastic material is therefore a secondary raw material. Concerning the characterisation of plastic material waste, reference is made to the standard DIN EN 15347:2007.

At least one of the layers made of air-permeable material of the filter material piece is thus a non-woven fabric that comprises recycled plastic materials and, in particular, is formed from recycled plastic materials.

In contrast to the respirator masks known from the prior art, less or no fresh/pure (virgin) plastic material (primary material) is used for the production of the non-woven fabrics on which the filter material piece of the respirator mask is based; instead, mainly or exclusively plastic materials are used that have already been in use and have been recovered by appropriate recycling processes (secondary material). Such respirator masks are clearly advantageous from an ecological point of view, as they may be manufactured in a highly neutral way regarding the raw material.

In one embodiment, the fibres of one or more non-woven fabrics included in the air-permeable material of the filter material piece or filter part of the respirator mask are formed from a single recycled plastic material.

Alternatively, it is however also possible that the fibres of one or more non-woven fabrics are formed from different materials, at least one of which is a recycled plastic material. Two embodiments in particular are conceivable here:

On the one hand, it may be a mixture of at least two types of fibres, for example fibre mixtures formed from at least two different recycled plastic materials.

On the other hand, it is also possible that the non-woven fabric includes or is formed from bicomponent fibres (bico fibres). These may consist of a core and a shell surrounding the core. Core and shell are made of different materials. In addition to core/shell bicomponent fibres, the other common variants of bicomponent fibres (e.g. side by side) may also be considered.

The bicomponent fibres may be staple fibres or be configured as an extrusion non-woven fabric (for example as meltblown, spunbond or spun-blown non-woven fabric), the bicomponent fibres theoretically having infinite length and building so-called filaments. In the case of such bicomponent fibres, it is an advantage if at least the core is made of a recycled plastic material; a virgin plastic material, but alternatively another recycled plastic material, may also be used for the shell for example.

Bicomponent fibres whose core consists of recycled polyethylene terephthalate (rPET) or recycled polypropylene (rPP), the shell consisting of polypropylene, which may be a virgin or a recycled material, are particularly advantageous.

In particular, when the bicomponent fibres are used as binder fibres, both core and shell may be made of recycled plastic materials. When the bicomponent fibres are meltblown, the shell consists preferably of virgin material to be reliably persistently chargeable.

As non-woven fabrics for the purposes of the present invention dry-laid, wet-laid or extrusion non-woven fabrics may be used. Thus the fibres of the non-woven fabrics may be of finite length (staple fibres), but also theoretically of infinite length (filaments).

The respirator mask may in particular consist of the filter material piece and the at least one securing band. The securing band may be welded or glued to the filter material piece. According to an alternative, the securing band may also be coupled to the filter material piece by interlocking, for example by means of a rivet.

The filter material piece forms the filter part of the respirator mask, providing the filtering of the inhaled and exhaled air.

The recycled plastic material may be selected from the group consisting of recycled polyesters, in particular recycled polyethylene terephthalate (rPET), recycled polybutylene terephthalate (rPBT), recycled polylactic acid (rPLA), recycled polyglycolide and/or recycled polycaprolactone; recycled polyolefins, in particular recycled polypropylene (rPP), recycled polyethylene and/or recycled polystyrene (rPS); recycled polyvinyl chloride (rPVC), recycled polyamides and mixtures and combinations thereof.

There are relevant international standards for many plastic material recyclates. For PET plastic material recyclates, for example, DIN EN 15353:2007 is relevant. PS recyclates are described in more detail in DIN EN 15342:2008. PE recyclates are dealt with in DIN EN 15344:2008. PP recyclates are characterised in DIN EN 15345:2008. PVC recyclates are described in more detail in DIN EN 15346:2015. For the purpose of the corresponding special plastic material recyclates, the present patent application adopts the definitions of these international standards. The plastic material recyclates may be obtained from metallised or non-metallised raw materials. One example of non-metallised raw materials are plastic material flakes or chips recovered from PET beverage bottles. Likewise, the raw materials may be metallised, e.g. if they have been obtained from metallic plastic material films, in particular metallised PET films (MPET).

The recycled plastic material is in particular recycled polyethylene terephthalate (rPET), obtained for example from beverage bottles, in particular from so-called bottle flakes, i.e. pieces of ground beverage bottles.

The recycled plastic materials, in particular the recycled PET, in both the metallised and non-metallised version, may be spun into the appropriate fibres from which the corresponding staple fibres or meltblown or spunbond non-woven fabrics may be produced for the purposes of the present invention.

In one variant, the air-permeable material may have a single-layer structure, i.e. be composed of exactly one layer of a non-woven fabric as described, i.e. consist of this layer. The non-woven fabric may be spun-blown, in particular made of bicomponent fibres. As described above, the core may be formed from a recycled plastic material, and a virgin/primary plastic material may be used for the shell, for example. The non-woven fabric may be calendered. This increases the strength.

A spun-blown non-woven fabric may be electrostatically charged (e.g. by corona charging or hydro charging).

In another variant, the air-permeable material may be multi-layered, wherein at least one, more or all of the layers comprise or are formed from a non-woven fabric, wherein the non-woven fabric comprises or is formed from fibres comprising or being formed from one or more recycled plastic materials. A specific choice of the individual non-woven fabric and its parameters enables adjusting the filtering properties of the respirator mask in a controlled manner.

In the case of a multi-layer structure, the layers may be welded together along their edges.

The present invention covers several particularly preferred ways of designing the air-permeable material with multiple layers, which are presented below. The plurality of these layers may be joined together by means of welded joints. The layers may also be glued together.

The filter part or the filter material piece of the (finished but unused) respirator mask may have (in top view) a polygonal, in particular substantially rectangular shape. This also applies in particular to the case of a filter material piece with folds. The filter part or the filter material piece may have a three-dimensional shape, for example caused by spatial reshaping. The latter in particular allows a more precise fit to the face shape, resulting in a lower leakage volume flow.

According to one embodiment, the air-permeable material comprises at least one support layer and at least one fine filter layer, wherein at least one or all of the support layers comprise or are formed from recycled plastic materials and/or at least one or all of the fine filter layers are non-woven fabrics comprising or formed from one or more recycled plastic materials.

In particular, the fine filter layer enables the desired protection and filtering function of the respirator mask.

A multi-layer air-permeable material may have a meltblown layer between two support or carrier layers. The meltblown layer, which is the fine filter layer, enables a high filter performance. The meltblown layer may be electrostatically charged (e.g. by corona charging or hydro charging).

One or both carrier layers may be a non-woven fabric, in particular spunbonded or spun-blown. Alternatively, one or both carrier layers may be a mesh (netting). The mesh may have characteristics as described in EP 2 011 556 A1, which is hereby incorporated by reference.

A support layer (sometimes also called “carrier layer” or “reinforcing layer”) within the meaning of the present invention is a layer which provides the necessary mechanical strength to the multi-layer composite of the filter material piece. This refers to an open, porous non-woven fabric or a non-woven fabric with a light weight per unit area. One of the purposes of a support layer is to support other layers. The support layer, as well as any other layer of the filter material, may also be electrostatically charged, provided that the material has suitable dielectric properties.

A fine filter layer serves to increase the filtration performance of the multi-layer filter material piece by trapping particles that pass through the support layer, for example. To further increase the separation efficiency, the fine filter layer may preferably be electrostatically charged (e.g. by corona discharge or hydro charging).

Each support layer of the respirator masks may be a spunbonded non-woven, preferably with a grammage between 5 and 80 g/m², more preferably between 10 and 50 g/m², more preferably between 15 and 30 g/m² and/or preferably with a titre of the filaments forming the spunbonded non-woven in the range of 0.5 to 15 dtex.

The air-permeable material may preferably comprise one to three support layers.

When two support layers exist, the total grammage of the sum of all support layers is preferably 10 to 200 g/m², more preferably 15 to 150 g/m², more preferably 20 to 100 g/m², more preferably 30 to 90 g/m², in particular 40 to 70 g/m².

It is particularly preferred that all support layers are formed from one or more recycled plastic materials, in particular rPET or rPP.

According to a further advantageous embodiment, each fine filter layer is an extruded non- woven fabric, in particular a meltblown non-woven fabric, preferably with a grammage of 10 to 80 g/m², more preferably 15 to 50 g/m², in particular 20 to 40 g/m².

The air-permeable material may comprise 1 to 5 fine filter layers.

When at least two fine filter layers exist, the total grammage of the sum of all fine filter layers is preferably 10 to 80 g/m², more preferably 15 to 50 g/m², in particular 20 to 40 g/m².

It is particularly preferred that at least one, preferably all, fine filter layers comprise or are formed from one or more recycled plastic material, in particular comprising an rPP. In this case, the at least one fine filter layer may be a bicomponent meltblown non-woven, wherein the core of the bicomponent fibres is formed from an rPP.

To increase the filtration performance, at least one, preferably all, fine filter layers may be electrostatically charged.

In a multilayer construction, at least one of the layers may comprise at least one recycled plastic material, in particular rPET or rPP. Particularly preferably, at least all support layers are made of recycled plastic materials.

The air-permeable material of the respirator mask may comprise a meltblown layer made of bicomponent fibres having a core/shell construction, the core being formed of rPP and the shell being formed of virgin PP. In particular, the core portion may constitute at least 60%, at least 80% or at least 90% of the bicomponent fibres. This allows a high recycled content with good electrostatic chargeability, the latter resulting in particular from the use of virgin PP for the shell.

In the respirator masks described, the at least one securing band may comprise a recycled plastic material or be formed from one or more recycled plastic materials. This allows a further increase in the recycled content of the entire respirator mask.

The at least one securing band may comprise or consist of a layer of a film and/or a layer of a non-woven fabric, for example a meltblown fabric. The non-woven fabric and/or the laminate of the two layers may be a creped material. Alternatively or additionally, Vistamaxx (manufacturer: ExxonMobil Chemical) may be used as a material for the non-woven fabric.

The at least one securing band may have a multi-layer structure, wherein the securing band comprises or consists of a layer of a film and a layer of a non-woven fabric, in particular a meltblown fabric.

In the case of a securing band in the form of a laminate comprising a film and a non-woven fabric, the film, in particular in the form of a cast film, may be laminated directly onto the non-woven fabric. Thus no additional adhesive is required.

At least one layer of the at least one securing band may be creped. The creped layer may be obtained, for example, by means of the Micrex micro-creping process. In the case of a multi-layer securing band, the laminate of the multiple plies may be a creped material.

The creping of the creped layer of the at least one securing band may be stabilised by means of an adhesive applied, in particular an adhesive that is elastic in the cured state. A hot melt adhesive is particularly suitable as an adhesive. The adhesive may be applied to the creped layer in the form of one or more strips, in particular in the longitudinal direction of the securing band. This leads to an advantageous stabilisation or fixation of the crepe without affecting the overall elasticity of the securing band too much.

The at least one securing band may comprise or be formed from a thermoplastic polymer, in particular a recycled thermoplastic polymer. The thermoplastic polymer may in particular be a thermoplastic elastomer. It may be, for example, a thermoplastic polyurethane (TPU) or Vistamaxx. Thus the securing band may be in the form of a laminate of a TPU film and a TPU meltblown, TPU spunbonded or TPU spun-blown material. This construction results in good elasticity with a high stability of the securing band. Furthermore, such a securing band may be advantageously welded to the filter material piece.

The securing band may be configured as a torsade or twisted cord. This increases the wearing comfort. In this case, it is possible to prevent the twist from twisting back again by thermal fusing (e.g. ultrasonic welding).

The respirator masks described may comprise (exactly) two securing bands.

One or more securing bands may be designed to be guided around the back of the head of a wearer (user). Alternatively, one or more securing bands may be designed to be guided around a wearer's (user's) ear.

The at least one securing band may be designed as a closed strap. This means that the corresponding securing band has no loose or open end. This may be achieved, for example, by coupling both ends of a securing band to the filter part or the filter material piece. Alternatively, for example, the corresponding strap may be configured as a closed strap as such; it may therefore have a ring or loop shape.

According to an alternative, the respirator mask may have at least two, in particular four, securing bands with open or loose ends. This means that (only) one end of each securing band is attached to the filter part or a non-woven web. The open/loose ends of two securing bands each may be knotted.

The at least one securing band may extend over an entire length of the filter material piece or filter part. This allows that the at least one securing band runs with the air-permeable material during production and is cut together with the material (at the ends of the filter material piece).

In particular, two securing bands may be provided which extend over an entire length of the filter material piece or filter part. Preferably, these two securing bands are arranged on the same side of the air-permeable material or filter material piece and along two opposite edges of the filter material piece.

The at least one securing band may be coupled, in particular welded, to the air-permeable material at its two end regions.

The previously described respirator masks may include a bendable nosepiece. This allows to optimize the fit, in particular to enhance the sealing of the respirator mask in the eye and nose area, as well as to improve the retention.

In this case, the respirator mask may consist of the air-permeable material, the at least one securing band and the nosepiece.

The nosepiece may be in a arrangement parallel to the non-welded edge. It may be placed on the outside of the respirator mask or embedded in one of the two non-woven webs.

The nosepiece may comprise a single or a double wire. The single or double wire may be embedded in a strip of plastic material or paper-based material.

The nosepiece may be made of aluminium or of PP or PE without wire insert. The plastic material may be formed from a recycled plastic material. The width of the nosepiece may be 1 to 10 mm.

The length of the nosepiece may be 2 to 25 cm, in particular more than 4 cm and/or less than 10 cm. The nosepiece may also extend along the entire length of one edge of the filter material piece. This allows a simplified production, as the nosepiece may be cut together with the filter material piece during the production.

The nosepiece may be attached to the filter material piece in a destructively detachable or non-destructively detachable manner. The nosepiece may be glued or welded to the filter material piece. The fastening by means of adhesive may be done by a hot-melt adhesive. The nose-piece may be coupled to the filter material piece continuously along its entire length or only at individual discrete points.

The respirator masks described above may be configured as half masks. In use, they cover thus the wearer's nose, mouth and chin. The respirator masks described above may be configured as medical face masks according to DIN EN 14683:2019+AC:2019 or as filtering half masks according to DIN EN 149.

The part by weight of all recycled materials relative to the total weight of the respirator mask may be at least 60%, in particular at least 70%, in particular at least 80%, in particular at least 90%, in particular 95%.

The securing band of the respirator masks described above may be creped. The Micrex/microcreper process in particular may be used also in this case.

A creped securing band allows an advantageous flexibility enabling an adaptation to different head diameters.

Further the present invention relates to the use of a creped non-woven fabric for a respirator mask or a protective garment, in particular the manufacturing of a respirator mask or a protective garment. Regarding the creped plastic materials that may be used for this purpose or the possible design of the non-woven fabrics, reference is made in this respect to the preceding explanations.

The present invention will be elucidated in more detail by means of the following exemplary embodiments with reference to the figures, without limiting the invention to the specific embodiments shown. In which:

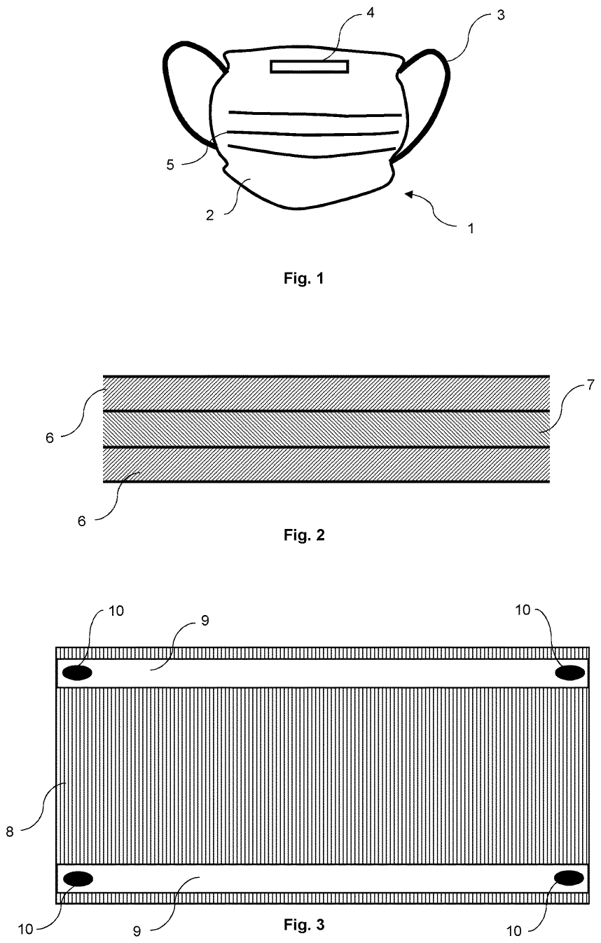

FIG. 1 schematically shows a respirator mask,

FIG. 2 shows a schematic cross-sectional view of the structure of a filter material piece of a respirator mask,

FIG. 3 shows a schematic top view of a respirator mask,

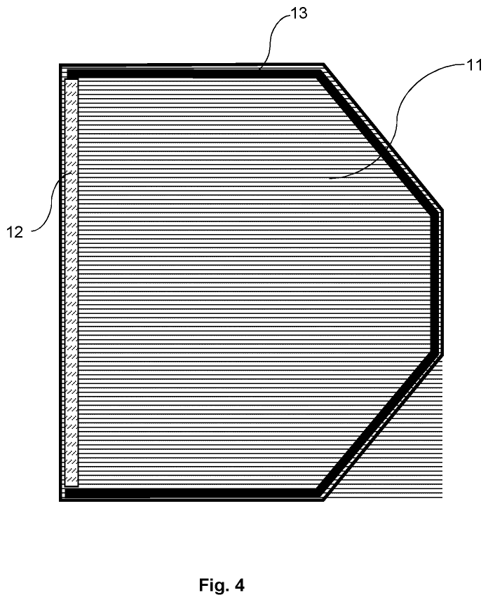

FIG. 4 shows a schematic side view of the filter part of a respirator mask.

FIG. 1 shows a schematic view of a respirator mask 1 in the form of a half mask. The description refers to an example of a medical face mask. The respirator mask 1 shown comprises a filter material piece or filter part 2. The cutting shape of the filter material piece is basically rectangular, but may also take on other shapes, in particular polygonal shapes.

Two securing bands 3 are attached to the filter material piece 2 in the example shown. In the illustrated embodiment, the attachment straps are provided for attachment to the ears of the wearer.

For a better adaptation to the shape of the face, the respirator mask has a nosepiece 4 which is coupled to the filter material piece in a destructively or non-destructively detachable manner. In particular, the nosepiece may be a wire embedded in a plastic material.

A destructive connection consists of welding, for example. The welding may either be disposed continuously along the entire length of the nosepiece or at individual discrete points. Alternatively, the nosepiece may be glued to the filter material piece. For example, a hot melt may be used for this purpose, which typically also results in a destructive connection.

Alternatively, the nosepiece is provided to the user as a separate element. In this case, the nosepiece has a self-adhesive surface that is initially covered with a protective film. After removing the protective film, the user sticks the nosepiece onto the non-woven fabric. Depending on the adhesive material used, such a nosepiece may also be reused for other respiratory protection filter parts.

In the exemplary embodiment, three folds 5 are disposed in the filter part or the air-permeable material 2.

The schematic cross-sectional view of FIG. 2 shows the structure of a filter material piece for a respirator mask. A fine filter layer 7 is arranged between two support layers 6. The three layers may in particular be welded together along the edges, i.e. the circumference, of the filter part 2, as illustrated in FIG. 1.

As an alternative to the structure shown in FIG. 2, the air-permeable material of the respirator mask may also comprise fewer or more layers. For example, only one support layer and one fine filter layer may be provided.

In one embodiment, the respirator masks have one or more layers made of rPET or rPP filaments or rPET or rPP staple fibres. Regarding the individual filter layers:

Spunbonded non-woven layers made of rPET or rPP with a weight per unit area of 5 to 50 g/m² and a titre of 1 to 15 dtex are particularly suitable as support layers 6. For example, PET waste (e.g. punching waste) and so-called bottle flakes, i.e. pieces of ground beverage bottles, are used as raw materials. To cover the different colouring of the waste, it is possible to dye the recyclate. The HELIX® (Comerio Ercole) process is particularly advantageous as a thermal bonding process for bonding the spunbonded non-woven fabric.

One or more layers of meltblown non-woven made of rPET or rPP with a weight per unit area of 5 to 30 g/m² each are used as fine filter layers 7. In addition, one or more meltblown non-woven fabric layers made of virgin PP may be present. At least this layer/these layers is/are electrostatically charged. The layers of rPET or rPP may also be electrostatically charged. In this case no metallised PET waste may be used for production. Alternatively, the meltblown filaments may also consist of bicomponent fibres in which the core is made of rPET or rPP and the shell is made of a plastic material that may be particularly well electrostatically charged (e.g. virgin PP, PC, PET).

The filaments or staple fibres may also consist of bicomponent fibres in which the core is made of rPET or rPP and the shell is made of a plastic material that may be particularly well electrostatically charged (e.g. virgin PP, PC, PET).

Specifically, the filter material piece may consist of a three-layer air-permeable material. A meltblown non-woven fabric layer with a grammage of 20 g/m² is arranged between two spun-bonded non-woven fabric layers made of rPET with a grammage of 20 g/m². The SMS thus obtained may be ultrasonically welded by a weld seam running along the edges.

The meltblown non-woven fabric may be electrostatically charged by adding additives and a water jet treatment (hydro charging), as described for example in WO 97/07272.

Alternatively, the meltblown non-woven fabric may have a grammage of 25 g/m² and may have been electrostatically charged by means of a corona treatment.

The meltblown non-woven fabric may consist of bicomponent fibres that have a core made of rPP and a shell made of virgin PP. For example, the meltblown non-woven fabric may be produced with a meltblown machine from Hills Inc., West Melbourne, Fla., USA. This allows to achieve high recycled content despite electrostatic charging.

The illustrated SMS was subjected to a Micrex micro-creping process. In other words, the entire laminate is creped. In an alternative embodiment, only individual layers may be creped. For example, the centrally located meltblown layer 7 may be creped, whereas the spunbonded support layers 6 are not creped. In this case, the support layers also serve to stabilise the creping of the meltblown layer, among other things. This is particularly advantageous if the material used for the meltblown layer per se does not readily hold the creping, as is the case for polypropylene, for example.

Purely by way of example, reference is made to WO 2007/079502 for creping. The resulting increase in surface area leads to a better fit of the respirator mask made from it to the shape of the wearer's head and face. It also results in a softer feel and improved moisture absorption.

In principle, virgin/primary plastic materials may also be used instead of some or all of the recycled plastic materials mentioned.

FIG. 3 shows a schematic top view of an air-permeable material 8 corresponding to the filter part 2 of FIG. 1. However, in comparison with FIG. 1, FIG. 3 shows the rear of the filter part, i.e. the side facing a user.

In the example shown, a securing band 9 is arranged on opposite edges of the air-permeable material 8 and extends along the entire length of the edge. The securing bands may thus run with the air-permeable material during the production of the filter part and be cut together with the material. In the example shown, the securing band and the air-permeable material are joined by means of a welding point 10 at each of the opposite end regions of each securing band 9.

For the securing band, for example, a TPU laminate consisting of a TPU film with a thickness of 20 to 100 μm and a TPU meltblown non-woven (grammage: 20 to 80 g/m²) is used, which is welded to the filter material piece. The TPU film used in each case is made of plastic material recyclate. For welding, the process disclosed in European patent applications EP 18213001.3 and EP 19180533.2 in another technical field may be used to achieve high strength.

The PP material produced according to the Vistamaxx process may have been produced by meltblown or foil casting or blown film processes and—as described for the TPU laminate—may have been laminated.

In the illustrated example according to FIG. 3, the air-permeable material is again creped as a whole. The crepe direction indicated by the hatching, i.e. the direction of the crepe folds, is vertical when the respirator mask is used as intended. In this example, the creping direction is transverse to the machine direction of the production machine, which runs from left to right in the drawing.

Preferably, the creping is done during production before the layers of the filter material piece are welded together. In this way, the creping is stabilised.

(Macroscopic) transverse folds—such as the folds 5 in FIG. 1—may be made in the filter material piece 8 parallel to the securing bands 9, transverse to the crepe folds. These folds are obtained by folding the air-permeable material so that areas of the air-permeable material lie on top of each other in the area of the folds or transverse folds in the finished, unused state of the filter material piece.

FIG. 4 shows a schematic side view of the filter part of a respirator mask. The filter section comprises two filter material pieces 11; only one of these is illustrated in FIG. 4.

Both filter material pieces have a hexagonal shape and fit exactly on top of each other. Thus, the filter part formed by the filter material pieces 11 welded together also has a hexagonal shape as such (in finished but unused state).

The edge on the left is disposed between two right angles, so it is bounded by two parallel edges that are perpendicular to the edge in between.

The air-permeable material of both filter material pieces is creped. The crepe direction is also indicated here by the hatching; the crepe folds run essentially horizontally, when the respirator mask made from the filter part is used as intended.

Each of the two filter material pieces 11 has a SMS structure, as explained, for example, in connection with FIG. 2. The three layers of a filter material piece have first been welded together along the edge between the two right angles, on the left side in the figure. The corresponding welding seam 12 of the filter material piece 11 shown runs parallel to the left edge.

The welding seam 13 along the remaining five edges is a welding of the two filter material pieces together. At these edges, there is no separate welding of the SMS layers of a filter material piece as such. On the side of the welding seam 12, however, the two filter material pieces are not welded together. This forms the open side of the respirator mask, which will face the wearer's face.

During manufacture thus, the three layers of SMS in the form of non-woven fabric webs are first laid loosely on top of each other and welded along one edge by means of the welding seam 12. The remaining five edges remain open, the layers therefore loose. The machine direction of the production machine is from top to bottom in the arrangement of FIG. 4, parallel to the welding seam 12. The SMS filter material web welded on one side only is then creped as a whole, wherein the creping direction, i.e. the direction of the creping folds, is transverse, i.e. essentially perpendicular to the machine direction or the welding seam 12.

Thereafter, two such creped SMS filter material webs are guided over each other in machine direction, i.e. in the direction of or parallel to the welding seam 12, so that they come to lie on top of each other. The two SMS filter material webs, i.e. the six layers of two SMS on the whole, are welded together along the welding seam 13, which forms five edges of the two filter material pieces lying on top of each other. The two filter material webs are punched along these edges, so that a filter part 11 is then obtained as shown in FIG. 4.

The resulting respirator mask is advantageously stretchable, in particular on its open side, i.e. in the area of the welding seam 12, which allows a good facial fit. In addition, due to the creping, the air permeability is high and the breathing resistance is low.

1. A respirator mask, comprising a filter material piece made of an air-permeable material and at least one securing band,
wherein the air-permeable material comprises at least one layer of non-woven fabric and the at least one layer of non-woven fabric is creped, and
wherein the at least one securing band is configured to secure the respirator mask to a user's head.

2. The respirator mask according to claim 1, wherein the air-permeable material is creped.

3. The respirator mask according to claim 1, comprising a further filter material piece made of an air-permeable material, wherein the further filter material piece comprises at least one layer of a non-woven fabric which is creped, and
wherein the filter material piece and the further filter material piece are partially welded together along their edge.

4. The respirator mask according to claim 1, wherein the air-permeable material is formed in multiple layers with a layer sequence:
a support layer, one or two fine filter layers, and a further support layer.

5. The respirator mask according to claim 1, wherein the non-woven fabric comprises fibres formed from one or more recycled plastic materials.

6. The respirator mask according to claim 5, wherein the recycled plastic material is selected from the group consisting of recycled polyesters recycled polyolefins, recycled polyvinyl chloride (rPVC), recycled polyamides, and mixtures and combinations thereof.

7. The respirator mask according to claim 1, wherein the air-permeable material is multi-layered, wherein at least one layer of the multi-layered air-permeable material comprises or is formed from a non-woven fabric, and wherein the non-woven fabric comprises or is formed from fibres comprising or being formed from one or more recycled plastic materials.

8. The respirator mask according to claim 1, wherein the air-permeable material comprises at least one support layer and at least one fine filter layer,
and wherein at least one, several or all of the support layers or at least one, several or all of the fine filter layers are non-woven fabrics comprising or formed from one or more recycled plastic materials.

9. The respirator mask according to claim 8, wherein
a) each fine filter layer is an extruded non-woven fabric with a grammage of 10 to 80 g/m²,
b) the air-permeable material comprises 1 to 5 fine filter layers,
c) when at least two fine filter layers exist, a total grammage of a sum of all fine filter layers is 10 to 80 g/m²,
d) at least one support layer is formed from one or more recycled plastic materials,
e) at least one fine filter layer is electrostatically charged.

10. The respirator mask according to claim 1, wherein the air-permeable material comprises a meltblown layer of bicomponent fibres having a core/shell construction, the core being formed of rPP and the shell being formed of virgin PP.

11. The respirator mask according to claim 1, wherein the at least one securing band comprises a recycled plastic material or is formed from one or more recycled plastic materials.

12. The respirator mask according to claim 1, wherein the at least one securing band has a multi-layer construction, the securing band comprising a layer of a film and a layer of a meltblown material.

13. The respirator mask according to claim 1, wherein the securing band comprises or is formed from a thermoplastic material polymer.

14. The respirator mask according to claim 1, wherein a part by weight of all recycled materials relative to a total weight of the respirator mask is at least 60%.

15. (canceled)

16. The respirator mask according to claim 6, wherein the recycled polyesters comprise recycled polyethylene terephthalate (rPET), recycled polybutylene terephthalate (rPBT), recycled polylactic acid (rPLA), recycled polyglycolide, or recycled polycaprolactone.

17. The respirator mask according to claim 6, wherein the recycled polyolefins comprise recycled polypropylene (rPP), recycled polyethylene, or recycled polystyrene (rPS).

18. The respirator mask according to claim 1, comprising a further filter material piece made of an air-permeable material, wherein the further filter material piece comprises at least one layer of a non-woven fabric which is creped.

19. The respirator mask according to claim 1, wherein the air-permeable material is multi-layered, and wherein at least one, more or all of the layers of the multi-layered air-permeable material comprise or are formed from a non-woven fabric.

20. The respirator mask according to claim 1, wherein the air-permeable material comprises at least one support layer and at least one fine filter layer.

21. The respirator mask according to claim 1, wherein the at least one securing band has a multi-layer construction.
